(19) United States
(12) Patent Application Publication
(10) Pub. No.: US 2019/0368793 A1
(43) Pub. Date: Dec. 5, 2019

(54) A METHOD AND SYSTEM FOR REDUCING PROPANE CONTENT IN A REFRIGERANT CONTAINING PROPANE

(71) Applicant: RELIANCE INDUSTRIES LIMITED, Mumbai, Maharashtra (IN)

(72) Inventors: Ravikumar VEMURI, Jamnagar, Gujarat (IN); Rammohan MITTAPALLY, Jamnagar, Gujarat (IN)

(73) Assignee: RELIANCE INDUSTRIES LIMITED, Mumbai, Maharashtra (IN)

(21) Appl. No.: 16/461,573

(22) PCT Filed: Nov. 17, 2017
(86) PCT No.: PCT/IB2017/057202

§ 371 Date: May 16, 2019

(30) Foreign Application Priority Data
Nov. 18, 2016 (IN) 201621039335

(51) Int. Cl. F25B 43/04; F25J 1/02; B01D 5/00; F25J 1/00; F25B 45/00

(52) U.S. Cl. CPC F25B 43/043; F25J 1/0291; F25J 1/025; F25J 1/0052; F25B 45/00; B01D 5/0093

(57) ABSTRACT

The present disclosure relates to a method and system for reducing propane content in a refrigerant containing propane. The refrigerant is then used for maintaining the required temperature range in a reactor. Compared to a conventional system and method, the system and method of the present disclosure are capable of reducing the propane content in a refrigerant and maintaining the required temperature range in the reactor effectively.

### FIELD

The present disclosure relates to a method and system for reducing propane content in a refrigerant containing propane.

### DEFINITIONS

As used in the present disclosure, the following terms are generally intended to have the meaning as set forth below, except to the extent that the context in which they are used indicate otherwise.

Lighter hydrocarbon—refers to a hydrocarbon containing C₃ carbon atoms.

Recycled refrigerant—refers to a refrigerant which is re-circulated into reactor chillers, and a reactor for maintaining a desired temperature range in the reactor.

### BACKGROUND

Hydrocarbons, particularly C₄ olefins and iso-butane, react with each other in the presence of sulfuric acid to produce saturated hydrocarbons. The reaction is carried out in at least one reactor comprising a plurality of compartments. The reaction temperature in a first compartment of the reactor is less than that of a second compartment of the reactor. In order to get saturated hydrocarbons of a desired quality and quantity, it is necessary to carry out the reaction at a temperature in the range of 5° C. to 10° C., which is maintained by circulating a liquid refrigerant comprising butane, iso-butane, and propane (typically greater than 6 vol %). Since, the reaction is highly exothermic, the amount of heat released is absorbed by the liquid refrigerant, thereby vaporizing the liquid refrigerant to obtain refrigerant vapors. The refrigerant vapors leaving the reactor contain higher amounts of lighter hydrocarbons, particularly propane, which needs to be reduced to avoid accumulation.

FIG. 1 illustrates a conventional system (100) for reducing propane content in a refrigerant. The conventional system (100) comprises a primary knock out drum (10a), a primary compressor (20a), a primary condenser (30a), a primary receiver (40a), a first pump (50a), a de-propanizer (60) and a flash vessel (70).

The primary knock out drum (10a) is adapted to receive first vapors (2) of the refrigerant containing the lighter hydrocarbons greater than 6 vol % from a reactor (5).

The primary compressor (20a) is configured to compress the first vapors (2) received from the primary knock out drum (10a) to generate compressed first vapors (4). The primary compressor (20a) is a two stage compressor, wherein a first stage of the primary compressor (20a) operates at a pressure in the range of 0.5 kg/cm² to 2 kg/cm² and a second stage of the primary compressor (20a) operates at a pressure in the range of 2 kg/cm² to 6 kg/cm².

The first condenser (30a) is configured to condense the compressed first vapors (4) by circulating a condensing fluid (typically water) therethrough to generate first condensed refrigerant (6). The temperature of the condensing fluid is in the range of 20° C. to 40° C.

The first receiver (40a) is configured to receive the first condensed refrigerant (6) from the primary condenser (30a).

The first pump (50a) is configured to pump a first portion (6a), typically 8 to 10 vol % of the total first condensed refrigerant (6) to the de-propanizer (60) for separating the propane content therefrom to obtain liquid refrigerant with reduced lighter hydrocarbon content in the range of 3 vol % to 6 vol %. Depending upon the requirement, the separated propane (11) can be used for various purposes.

The flash vessel (70) is configured to receive a second portion (6b) of the first condensed refrigerant (6), typically 90 to 92 vol % of the total first condensed refrigerant (6), via the first pump (50a), and flash the second portion (6b) to obtain second vapors (8) of the refrigerant and liquid refrigerant (10). Typically, the second vapors (8) contain higher amount of propane than that of the liquid refrigerant (10). The entire second vapors (8) are recycled to the primary compressor (20a) and liquid refrigerant (10) is utilized for maintaining the temperature of 5° C. to 10° C. in the reactor (5). The temperature of the liquid refrigerant (10) is in the range of 15° C. to 20° C.

The flash vessel (70) is maintained at a pressure in the range of 1 kg/cm² to 3 kg/cm². Particularly, the flash vessel (70) is maintained at a pressure lower than that of the second stage of the primary compressor (20a). Due to this, the second portion (6b) of the first condensed refrigerant (6) is flashed in the flash vessel (70).

The refrigerant obtained using the conventional system comprises propane content in the range of 3 vol % to 6 vol %. Moreover, with time, the propane content in the first vapors (2) exiting the reactor (5) increases, i.e., the propane accumulates in the first vapors (2), thereby changing the dew point of the compressed vapors (4) with changing concentration of propane. Due to this, a higher compression ratio is required to compress the first vapors (2), thereby reducing the capacity of the primary compressor (20a), due to which the flow of refrigerant liquid (10) reduces and thus the production gets restricted, especially at peak capacity operation.

In summer conditions or when the medium temperature of the condensing fluid (water) is high, the rate of heat transfer in the primary condenser (30a) reduces, which in turn increases the compression ratio required. This results in reduction of the liquid refrigerant (10).

Therefore, there is felt a need for a method and a system that are capable of maintaining a desired range of propane content in a refrigerant.

### OBJECTS

Some of the objects of the present disclosure, which at least one embodiment herein satisfies, are as follows:

An object of the present disclosure is to provide a method and a system to maintain a desired range of propane content in a refrigerant.

Another object of the present disclosure is to improve the conventional system and method for reducing the propane content in a refrigerant.

Other objects and advantages of the present disclosure will be more apparent from the following description, which is not intended to limit the scope of the present disclosure.

### SUMMARY

The present disclosure relates to a method for reducing propane content in a refrigerant containing propane. The method comprises receiving first vapors of the refrigerant from a reactor. The received first vapors are compressed in a primary compressor to generate compressed first vapors. The first refrigerant vapors can contain propane in an amount greater than 6 vol %.

The compressed first vapors are condensing in a primary condenser to generate first condensed refrigerant. A first portion of the first condensed refrigerant is fed to a de-propanizer to remove propane therefrom and obtain a first portion of liquid refrigerant with reduced propane content. A second portion of the first condensed refrigerant is fed to a flash vessel to generate second vapors of the refrigerant and liquid refrigerant. The liquid refrigerant can contain propane in an amount in the range of 3 vol % to 6 vol %.

A first portion of the second vapors is fed to the primary compressor. A second portion of the second vapors of the refrigerant is compressed in an auxiliary compressor of the refrigerant to obtain auxiliary compressed vapors. The auxiliary compressed vapors are condensed in an auxiliary condenser to obtain auxiliary condensed refrigerant. The auxiliary condensed refrigerant is fed to the de-propanizer to remove propane therefrom, and obtain a second portion of liquid refrigerant with reduced propane content. The amount of propane reduced in the liquid refrigerant by the process of the present disclosure can be less than 3 vol %. The liquid refrigerant obtained in the process steps is fed to the reactor.

The first vapors of the refrigerant can be compressed at a pressure in the range of 0.3 kg/cm² to 6 kg/cm², and the second portion of the second vapors can be compressed at a pressure 1 kg/cm² to 7 kg/cm².

The present disclosure also relates to a system for reducing propane content in a refrigerant.

The system comprises a reactor, a primary compressor, a primary condenser, a flash vessel, an auxiliary compressor, an auxiliary condenser, a de-propanizer, a first conduit, a second conduit and a third conduit.

The primary compressor is configured to receive first vapors of the refrigerant from the reactor to generate compressed first vapors.

The primary condenser is configured to condense the compressed first vapors to obtain first condensed refrigerant.

The flash vessel is configured to receive a second portion of the first condensed refrigerant and generate second vapors of the refrigerant and liquid refrigerant.

The auxiliary compressor is configured to receive a second portion of the second vapors and generate auxiliary compressed vapors.

The auxiliary condenser is configured to receive the auxiliary compressed vapors and generate auxiliary condensed refrigerant.

The de-propanizer is configured to receive (i) a first portion of the first condensed refrigerant; and (ii) the auxiliary condensed refrigerant to generate liquid refrigerant with reduced propane content.

The first conduit is configured to lead the liquid refrigerant generated in the flash vessel to the reactor.

The second conduit is configured to lead the liquid refrigerant with reduced propane content to the reactor.

The third conduit is configured to lead a first portion of the second vapors to the primary compressor.

The auxiliary compressor can be a single stage compressor. The auxiliary compressor can be operated at a pressure in the range of 1 kg/cm² to 3 kg/cm².

The system can further include an auxiliary receiver. The auxiliary receiver can be configured to receive the auxiliary condensed refrigerant from the auxiliary condenser.

The system can still further include a pump. The pump can be configured to pump the auxiliary condensed refrigerant to the de-propanizer.

The system can still further include an auxiliary knock out drum. The auxiliary knock out drum can be configured to receive the second portion of the second vapors from the flash vessel.

### BRIEF DESCRIPTION OF ACCOMPANYING DRAWING

A method and system for reducing propane content in a refrigerant containing propane will now be described with the help of the accompanying drawing, in which:

FIG. 1 illustrates a conventional flow-diagram for reducing propane content in a refrigerant containing propane; and

FIG. 2 illustrates a flow-diagram for reducing propane content in a refrigerant containing propane in accordance with the present disclosure.

TABLE 1 provides a list of the reference numerals used:

| COMPONENTS | REFERENCE NUMERAL |
|---|---|
| Conventional system | 100 |
| Primary knock out drum | 10a |
| Primary compressor | 20a |
| Primary condenser | 30a |
| Primary receiver | 40a |
| First pump | 50a |
| Flash vessel | 70 |
| System | 200 |
| Auxiliary knock out drum | 10b |
| Auxiliary compressor | 20b |
| Auxiliary condenser | 30b |
| Auxiliary receiver | 40b |
| Second pump | 50b |
| Reactor | 5 |
| First vapors | 2 |
| Compressed first vapors | 4 |
| First condensed refrigerant | 6 |
| First portion | 6a |
| Second portion | 6b |
| De-propanizer | 60 |
| First portion of refrigerant | 7a |
| Second portion of refrigerant | 7b |
| Liquid Refrigerant | 10 |
| Propane | 11 |
| Second vapors | 8 |
| First portion | 8a |
| Second portion | 8b |
| Auxiliary compressed vapors | 12 |
| Auxiliary condensed refrigerant | 13 |
| First conduit | C1 |
| Second conduit | C2 |
| Third conduit | C3 |

### DETAILED DESCRIPTION

As described herein above, the refrigerant vapors (2) leaving the reactor (5) contain higher amount of propane. Due to this, the dew point of the compressed vapors (4) changes, thereby affecting the:
performance of the primary compressor (20a); and/or
overall capital expenditure (CAPEX) of the process for any new parallel system.

In order to obviate the above mentioned drawbacks, it is necessary to maintain the propane content of less than 3 vol % in a refrigerant. The present disclosure, therefore, envisages an improved method and system for reducing propane content in a refrigerant.

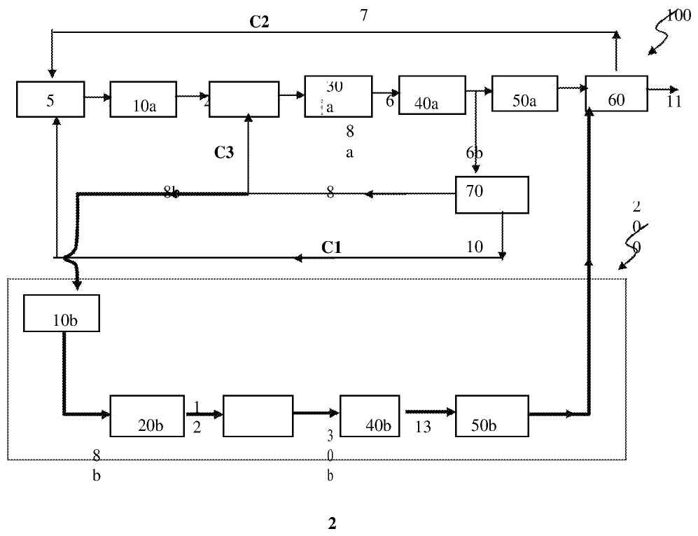

The improved method and the improved system are described with reference to FIG. 2. The system (200) comprises an auxiliary knock out drum (10b), an auxiliary (20b), an auxiliary condenser (30b), an auxiliary receiver (40b) and a second pump (50b).

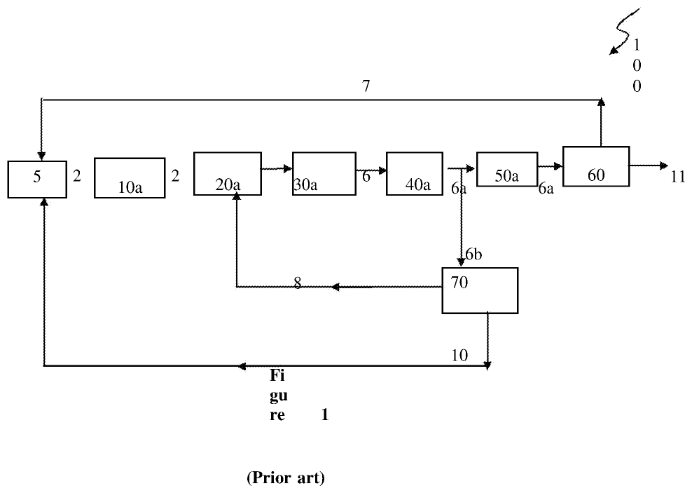

The process equipment, as depicted in the FIG. 1 and FIG. 2, are in fluid communication with each other by a suitable means (typically piping systems).

The method involves the following steps that are described herein below.

Conventionally, the second vapors (8) of the refrigerant generated in the flash vessel (70) contains propane in an amount greater than 4 vol %. In accordance with the present disclosure, the second vapors (8) are divided into two portions, viz., a first portion (8a) and a second portion (8b). The first portion (8a) of the second vapors (8) is re-circulated to the first compressor (20a), and the second portion (8b) of the second vapors (8) is introduced into the auxiliary compressor (20b) via the auxiliary knock out drum (10b). The second portion (8b) of the second vapors (8) is compressed in the auxiliary compressor (20b) to obtain auxiliary compressed vapors (12). In accordance an embodiment of the present disclosure, the auxiliary compressor (20b) is a single stage compressor, and the second portion (8b) of the second vapors (8) is compressed to a pressure in the range of 1 kg/cm² to 7 kg/cm² in the auxiliary compressor (20b).

The second vapors (8) from the flash vessel (70) cannot be directly introduced into the de-propanizer (60) for separating propane therefrom, because the operating pressure of the second vapors (8) is comparatively lower than that of the de-propanizer (60). Moreover, the de-propanizer (60) facilitates effective separation of propane when the de-propanizer (60 ) operates at a comparatively high pressure.

The auxiliary compressed vapors (12) is condensed in the auxiliary condenser (30b) by circulating a second condensing fluid (typically—water) having a temperature in the range of 20° C. to 40° C. there through, to obtain an auxiliary condensed refrigerant (13) having a temperature in the range of 35° C. to 40° C.

The auxiliary condensed refrigerant (13) is collected in the auxiliary receiver (40b). The auxiliary condensed refrigerant (13) is pumped to the de-propanizer (60) from the second receiver (40b) using the second pump (50b) to obtain a refrigerant (7) with reduced propane content of less than 3 vol %.

In accordance with the present disclosure, the liquid refrigerant (10) and the refrigerant (7) are re-circulated into the reactor (5) and/or chillers via a first conduit (C1) and a second conduit (C2), respectively, for maintaining the temperature of 5° C. to 10° C. in the reactor (5). In accordance with an embodiment of the present disclosure, the first portion (8a) of the second vapors (8) is introduced into the primary compressor (20a) via a third conduit (C3).

In accordance with one embodiment of the present disclosure, the auxiliary condensed refrigerant (13) and the first portion (6a) of the first condensed refrigerant (6) are pre-mixed and introduced into the de-propanizer (60) for separating propane (11) from the de-propanizer (60).

The method and the system (200 ) of the present disclosure facilitate in maintaining the propane content of less than 3 vol % in the refrigerant. This obviates the change in the dew point of the compressed first vapors (4), thereby achieving the desired performance of the primary compressor (20a).

The present disclosure is further described in light of the following simulation experiments which are set forth for illustration purpose only and not to be construed for limiting the scope of the disclosure. These simulation experiments can be scaled up to industrial/commercial scale and the results obtained can be extrapolated to industrial/commercial scale.

### Experimental Details

### Experiment 1: Method for Reducing Propane Content in a Refrigerant

The method is described with reference to FIG. 2. The first vapors (2) of the refrigerant containing propane content of 4 vol % were received in a primary knock out drum (10a) from a reactor (5). The first vapors (2) received from the primary knock out drum (10a) were compressed in the primary compressor (20a) to generate compressed first vapors (4). The primary compressor (20a) was a two stage compressor, wherein in a first stage of the primary compressor (20a) the first vapors (2) were compressed to a pressure of 2 kg/cm², and in a second stage of the primary compressor (20a) the first vapors (2) were further compressed to a pressure of 5 kg/cm².

The compressed first refrigerant (4) were condensed in a primary condenser (30a) by circulating water at a temperature of 28° C. through the primary condenser (30a), to generate first condensed refrigerant (6). The first condensed refrigerant (6) was received in a first receiver (40a), and a first portion (6a) (5 vol % of the total first condensed refrigerant (6)) of the first condensed refrigerant (6) from the first receiver (40a) was pumped to a de-propanizer (60), to obtain a first portion (7a) of liquid refrigerant with reduced propane content of 4 vol %.

A second portion (6b) (95 vol % of the total first condensed refrigerant (6)) of the first condensed refrigerant (6) was flashed in a flash vessel (70) to obtain second vapors (8) of the refrigerant and liquid refrigerant (10). The liquid refrigerant (10) was re-circulated into a reactor (5) by a second conduit (C2).

The second vapors (8) were divided into a first portion (8a) and a second portion (8b). The first portion (8a) of the second vapors (8) was recycled to the primary compressor (20a), and the second portion (8b) of the second vapors (8) was received in an auxiliary knock out drum (10b).

The second portion (8b) was compressed to a pressure of 6 kg/cm² in the auxiliary compressor (20b) to obtain auxiliary compressed vapors (12) of the refrigerant. The auxiliary compressed vapors (12) were condensed in an auxiliary condenser (30b) by circulating water at a temperature of 28° C. through the auxiliary condenser (30b), to obtain auxiliary condensed refrigerant (13).

The auxiliary condensed refrigerant (13) was received in an auxiliary receiver (40b), and the auxiliary condensed refrigerant (13) was pumped to the de-propanizer (60), to obtain a second portion (7b) of refrigerant with reduced propane content of 1 vol %.

The improved method of the present disclosure is capable of significantly reducing the liquid refrigerant purge through vapour purge route, as compared to the refrigerant using the conventional method steps, thereby reducing load to De-propaniser (60) at the same time making available higher quantity of low temperature refrigerant by additional 5%.

### Experiment 2: Method for Reducing Propane Content in a Refrigerant

The method is described with reference to FIG. 2. The first vapors (2) containing propane content of 4 vol % were received in a primary knock out drum (10a) from a reactor (5). The first vapors (2) received from the primary knock out drum (10a) were compressed in the primary compressor (20a) to generate compressed first vapors (4). The primary compressor (20a) was a two stage compressor, wherein in a first stage of the primary compressor (20a) the first vapors (2) were compressed to a pressure of 2 kg/cm², and in a second stage of the primary compressor (20a) the first vapors (2) were further compressed to a pressure of 5 kg/cm².

The compressed first refrigerant (4) were condensed in a primary condenser (30a) by circulating water at a temperature of 32° C. through the primary condenser (30a), to generate first condensed refrigerant (6). The first condensed refrigerant (6) was received in a first receiver (40a), and a first portion (6a) (10 vol % of the total first condensed refrigerant (6)) of the first condensed refrigerant (6) from the first receiver (40a) was pumped to a de-propanizer (60), to obtain a first portion (7a) of liquid refrigerant with reduced propane content of 1 vol %.

A second portion (6b) (90 vol % of the total first condensed refrigerant (6)) of the first condensed refrigerant (6) was flashed in a flash vessel (70) to obtain second vapors (8) of the refrigerant and liquid refrigerant (10). The liquid refrigerant was re-circulated into a reactor (5) by a second conduit (C2).

The second vapors (8) were divided into a first portion (8a) and a second portion (8b). The first portion (8a) of the second vapors (8) was recycled to the primary compressor (20a), and the second portion (8b) of the second vapors (8) was received in an auxiliary knock out drum (10b).

The second portion (8b) was compressed to a pressure of 6.5 kg/cm² in the auxiliary compressor (20b) to obtain auxiliary compressed vapors (12) of the refrigerant. The auxiliary compressed vapors (12) were condensed in an auxiliary condenser (30b) by circulating water at a temperature of 32° C. through the auxiliary condenser (30b), to obtain auxiliary condensed refrigerant (13).

The auxiliary condensed refrigerant (13) was received in an auxiliary receiver (40b), and the auxiliary condensed refrigerant (13) was pumped to the de-propanizer (60), to obtain a second portion (7b) of refrigerant with reduced propane content of 2 vol %.

The improved method of the present disclosure is capable of significantly reducing the liquid refrigerant purge through vapour purge route, as compared to the refrigerant using the conventional method steps, thereby reducing load to De-propaniser (60) at the same time making available higher quantity of low temperature refrigerant by additional 10%.

### TECHNICAL ADVANCES AND ECONOMICAL SIGNIFICANCE

The present disclosure described herein above has several technical advantages including, but not limited to, the realization of a system and process that are capable of:
reducing the lighter hydrocarbon content (particularly propane) in the refrigerant effectively, thereby maintaining the lighter hydrocarbon content in the refrigerant in the desired range (less than 3 vol %).

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed anywhere before the priority date of this application.

In view of the wide variety of embodiments to which the principles of the present invention can be applied, it should be understood that the illustrated embodiments are exemplary only. While considerable emphasis has been placed herein on the particular features of this invention, it will be appreciated that various modifications can be made, and that many changes can be made in the preferred embodiments without departing from the principle of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

1. A method for reducing propane content in a refrigerant containing propane, said method comprising:
a) receiving first vapors (2) of said refrigerant from a reactor (5);
b) compressing the received first vapors (2) in a primary compressor (20a) to generate compressed first vapors (4);
c) condensing the compressed first vapors (4) in a primary condenser (30a) to generate first condensed refrigerant (6);
d) leading a first portion (6a) of the first condensed refrigerant (6) to a de-propanizer (60) to remove propane (11) therefrom and obtain a first portion (7a) of liquid refrigerant with reduced propane content;
e) leading a second portion (6b) of the first condensed refrigerant (6) to a flash vessel (70) to generate second vapors (8) of said refrigerant and liquid refrigerant (10);
f) leading a first portion (8a) of the second vapors (8) to the primary compressor (20a);
g) compressing a second portion (8b) of the second vapors (8) in an auxiliary compressor (20b) to obtain auxiliary compressed vapors (12) of said refrigerant;
h) condensing the auxiliary compressed vapors (12) in an auxiliary condenser (30b) to obtain auxiliary condensed refrigerant (13);
i) leading the auxiliary condensed refrigerant (13) to the de-propanizer (60) to remove propane (11) therefrom, and obtain a second portion (7b) of liquid refrigerant with reduced propane content; and
j) leading the first, second portions of the liquid refrigerant (7a and 7b) and the liquid refrigerant (10) obtained in steps (d), (i) and (e) respectively to the reactor (5).

2. The method as claimed in claim 1, wherein the first vapors (2) of the refrigerant in the step a) contain propane in an amount greater than 6 vol %.

3. The method as claimed in claim 1, wherein the first portion (7a) of the liquid refrigerant obtained in the step d) contains propane in an amount in the range of 3 vol % to 6 vol %.

4. The method as claimed in claim 1, wherein the amount of propane in the second portion (7b) of the liquid refrigerant obtained in the step i) is less than 3 vol %.

5. The method as claimed in claim 1, wherein the first vapors (2) of the refrigerant are compressed in the step b) at a pressure in the range of 0.3 kg/cm² to 6 kg/cm², and the second portion (8b) of the second vapors (8) obtained in the step g) is compressed at a pressure 1 kg/cm² to 7 kg/cm².

6. A system for reducing propane content in a refrigerant containing propane, said system comprising:
a) a primary compressor (20a) for receiving first vapors (2) of the refrigerant from a reactor (5) to generate compressed first vapors (4);
b) a primary condenser (30a) for condensing the compressed first vapors (4) to obtain first condensed refrigerant (6);
c) a flash vessel (70) configured to receive a second portion (6b) of the first condensed refrigerant (6) and generate second vapors (8) of the refrigerant and liquid refrigerant (10);
d) an auxiliary compressor (20b) configured to receive a second portion (8b) of the second vapors (8) and generate auxiliary compressed vapors (12) of the refrigerant;
e) an auxiliary condenser (30b) configured to receive the auxiliary compressed vapors (12) and generate auxiliary condensed refrigerant (13);
f) a de-propanizer (60) configured to receive (i) a first portion (6a) of the first condensed refrigerant (6); and (ii) the auxiliary condensed refrigerant (13) to generate a second portion (7b) of the liquid refrigerant with reduced propane content.
g) a first conduit (C1) configured to lead the liquid refrigerant (10) generated in the flash vessel (70) to the reactor (5);
h) a second conduit (C2) configured to lead the liquid refrigerant (7) with reduced propane content to the reactor (5); and
i) a third conduit (C3) configured to lead a first portion (8a) of the second vapors (8) to the primary compressor (20a).

7. The system as claimed in claim 6, wherein said auxiliary compressor (20b) is a single stage compressor, said auxiliary compressor (20b) operates at a pressure in the range of 1 kg/cm² to 7 kg/cm².

8. The system as claimed in claim 6, further comprising an auxiliary receiver (40b) configured to receive said auxiliary condensed refrigerant (13) from said auxiliary condenser (30b).

9. The system as claimed in claim 6, further comprising a pump (50b) configured to pump the auxiliary condensed refrigerant (13) to the de-propanizer (60).

10. The system as claimed in claim 6, further comprising an auxiliary knock out drum (10b) configured to receive the second portion (8b) of the second vapors (8) from the flash vessel (70).
